(19) United States
(12) Patent Application Publication
(10) Pub. No.: US 2007/0153769 A1
(43) Pub. Date: Jul. 5, 2007

(54) Method of locating and transferring session information between access nodes in a radio access network

(76) Inventors: David Reeves Comstock, San Diego, CA (US); Erik Colban, San Diego, CA (US); Hai Le, Plano, TX (US); Prakash Surendranadhan, San Diego, CA (US); Prashanth Sharma, San Diego, CA (US); Rath Vannithamby, San Diego, CA (US); Robert Ottinger, LaJolla, CA (US); Sanjeevan Sivalingham, San Diego, CA (US); Srinivasan Balasubramanian, San Diego, CA (US); Vincent B. Baglin, San Diego, CA (US); Yingzhe Wu, San Marcos, CA (US)

Correspondence Address: COATS & BENNETT, PLLC, 1400 Crescent Green, Suite 300, Cary, NC, 27518, US

(21) Appl. No.: 11/323,454

(22) Filed: Dec. 30, 2005

(51) Int. Cl. H04L 12/66

(52) U.S. Cl. 370/352

(57) ABSTRACT

In a mobile communication network comprising a plurality of access nodes, session information for a communication session is stored in one access node and may be requested by a peer access node. A requesting access node determines the location of session information based on the mobile station identifier associated with the communication session. If the session information is transferred to the requesting node, the requesting node may allocate a new mobile station identifier to the mobile station for the communication session.

### BACKGROUND

The present invention relates generally to mobile communication networks and more particularly, to mobile communication networks having a distributed architecture.

Most radio access networks (RANs) employed today use a hierarchical network architecture in which each higher level entity supports multiple lower level entities. HRPD networks according to the Third Generation Partnership Project 2 (3GPP2) standard exemplify this type of hierarchical network. In HRPD networks, a packet control function performing session control and mobility management functions, connects multiple base station controllers (also known as access node controllers) to the core network. Each base station controller, in turn, connects to multiple radio base stations and performs radio resource control functions. The radio base stations communicate over the air interface with the mobile stations. This conventional hierarchical architecture has worked well for voice services and most packet data services.

Voice over IP (VoIP) is a service for routing voice conversations over the Internet or other packet-switched network instead of conventional circuit-switched networks. VoIP has existed for many years in fixed networks, and is only beginning to be incorporated into mobile communication networks. Unlike most packet data services, VoIP is very sensitive to delay. To reduce packet latency for VoIP, a distributed RAN architecture is evolving in which the radio base station, base station controller, and packet control function are integrated into a single network entity with its own connection to the PDSN. In the new distributed architecture, functions traditionally performed by centralized nodes, such as session management and mobility management, are distributed among a plurality of network nodes. This distributed architecture makes session management and mobility management more difficult.

### SUMMARY

The present invention relates to a method for transferring session information between access nodes in a mobile communication network having a plurality of access nodes. The access node storing session information for the mobile station assigns the mobile station a mobile station identifier. The mobile station identifier uniquely identifies the access node which allocates the mobile station identifier. When the mobile station subsequently moves into another cell, the target access node in the new cell can determine the location of the session information based on the mobile station identifier. The target access node can then request session information needed to establish a connection with the mobile station. In some embodiments, the access node creating the session may store the session information for the duration of the session. In other embodiments, the session information may be transferred from a source access node to a target access node when the mobile station moves between cells. In this case, the target access node can allocate a new mobile station identifier and the source access node may release the session information.

### BRIEF DESCRIPTION OF THE DRAWINGS

FIG. 1 illustrates an exemplary mobile communication network with a distributed architecture.

FIG. 2 illustrates grouping of access nodes to form subnets.

FIG. 3 illustrates logical elements in an exemplary access node for a mobile communication network.

FIG. 4 illustrates an exemplary procedure for establishing a packet data call.

FIGS. 5A and 5B illustrate methods of establishing a data transmission path to a target access node.

FIG. 6 illustrates the format of an exemplary Universal Access Terminal Identifier.

FIG. 7 is a call-flow diagram illustrating an exemplary session establishment procedure for establishing a packet data session.

FIG. 8 is a call-flow diagram illustrating an exemplary reactivation procedure for reactivating a dormant packet data session.

FIG. 9 is a call-flow diagram illustrating an exemplary handover procedure for handing over a mobile station during an active call.

FIG. 10 is a call flow diagram illustrating an exemplary procedure for transferring session information between two access nodes.

### DETAILED DESCRIPTION

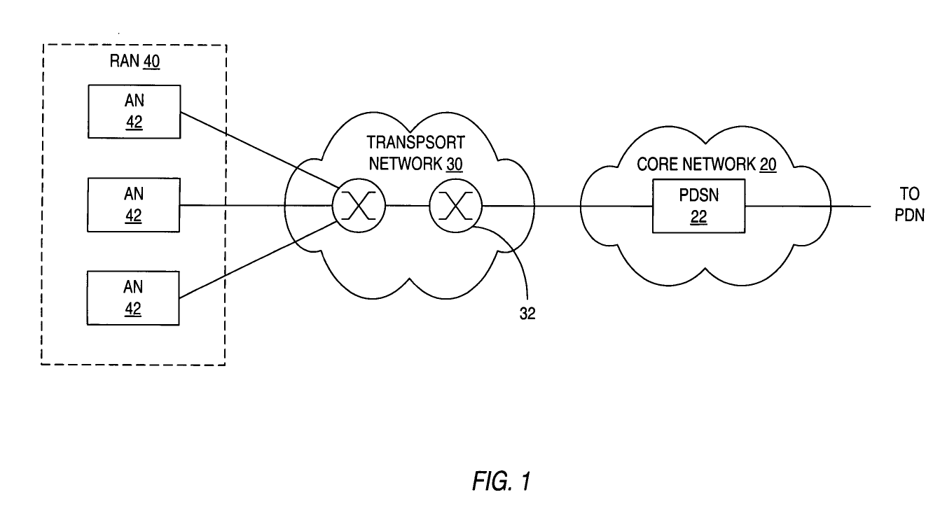

FIG. 1 illustrates a mobile communication network 10 according to one embodiment of the invention providing wireless packet data services to a plurality of mobile stations 100. Mobile communication network 10 has a distributed rather than hierarchical architecture. Mobile communication network 10 comprises a packet-switched core network 20 including a Packet Data Serving Node (PDSN) 22, an IP-based transport network 30, and a radio access network 40 comprising one or more access nodes (ANs) 42. The PDSN 22 connects to an external packet data network (PDN) 12, such as the Internet, and supports PPP connections to and from the mobile stations 100. The PDSN 22 adds and removes IP streams to and from the ANs 42 and routes packets between the external packet data network 12 and the ANs 42. The transport network 30 comprises one or more routers 32 and connects the ANs 42 with the core network 20. The ANs 42 provide the radio connection with the mobile stations 100. In one embodiment, each AN 42 provides coverage in an area referred to as a cell, which may be a multi-sector cell. The ANs 42 may operate, for example, according to the Telecommunications Industry Association (TIA) standard TIA-856-A, which defines an air interface between the AN 42 and mobile stations 100. Those skilled in the art will appreciate that the present invention may also use in other air interface standards, such as TIA-2000 and the emerging Wideband CDMA standard. As will be described in more detail below, the ANs 42, in contrast to conventional networks, incorporate functionality normally performed by higher level nodes in hierarchical systems.

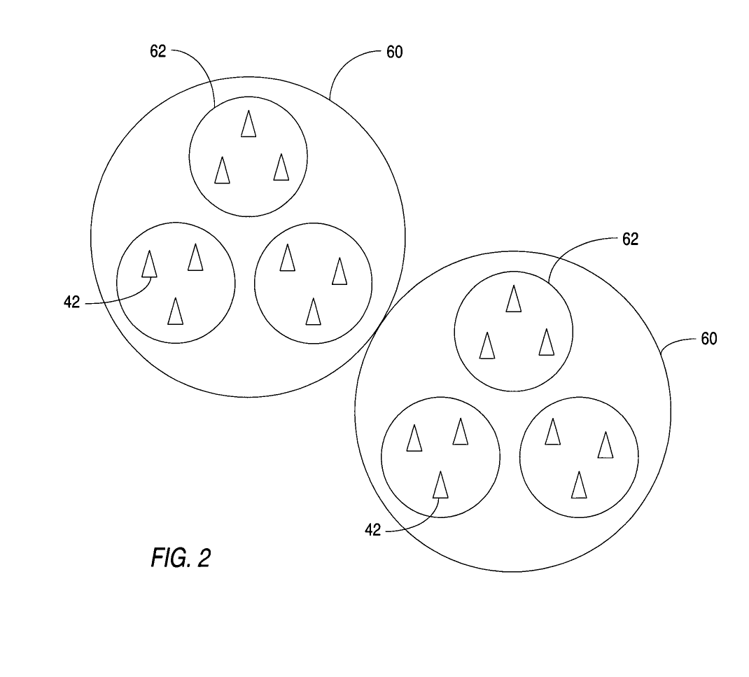

The ANs 42 are grouped to form subnets 60 as shown in FIG. 2. Each subnet 60 preferably covers a large area referred to herein as a multicast area. Each subnet 60 is further divided into smaller areas referred to herein as color code areas 62, which may encompass one or more ANs 42.

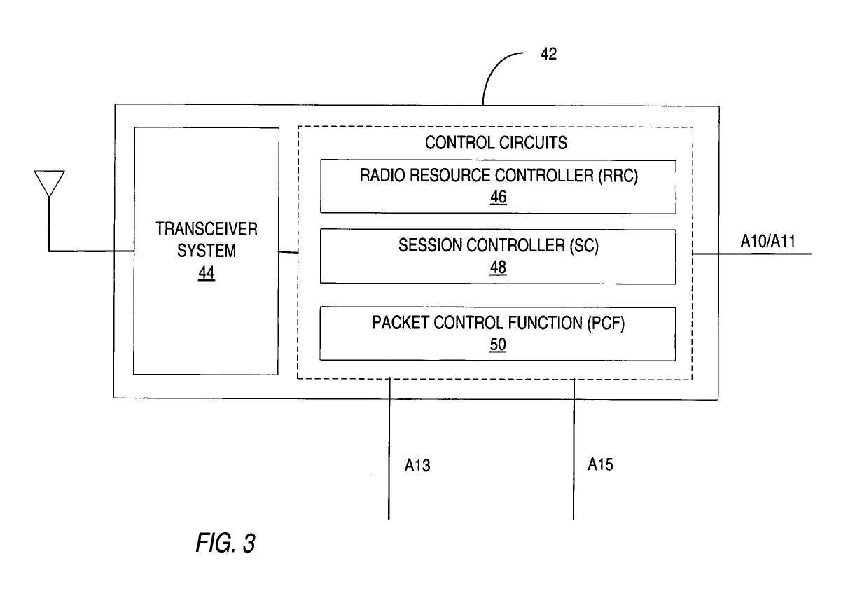

FIG. 3 illustrates the logical elements of an AN 42 in one exemplary embodiment. The exemplary AN 42 comprises a transceiver system 44 and a control unit, including a radio resource controller (RRC) 46, a session controller (SC) 48, and a Packet Control Function (PCF) 50 as defined in TIA-1878-1 (3GPP2 A.S0008 v3.0). The transceiver system 44 includes the radio equipment for communicating over the air interface with the mobile stations 100. The control unit may comprise a microprocessor, microcontroller, hardware or a combination thereof. The radio resource controller 46 manages radio and communication resources for the AN 42. The session controller 48 performs session control and mobility management (SC/MM) functions. The PCF 50 establishes, maintains, and terminates connections from the AN 42 to the PDSN 22. Thus, in contrast to conventional network architectures, the access nodes 42 in the exemplary embodiments integrate the functionality of an access network controller and packet control function as defined in TIA-1878-1 with a radio base station. The access network controller and packet control functions are thus distributed among all of the access nodes 32 rather than residing in a single node or location.

Between the AN 42 and the PDSN 22, the user data travels over the A10 communication link. Generic Routing Encapsulation (GRE) is used to transport data over the A10 connections. GRE is a well-known protocol for encapsulation of an arbitrary network layer protocol over another arbitrary network layer protocol. Signaling data travels between the AN 42 and PDSN 22 over the A11 link. Signaling between the ANs 42 travels over the A13 and A15 communication links. The A13 communication link is used to transfer session information between ANs 42. The A15 communication link is used for inter-AN paging. The AN 42 communicates with an AAA over the A12 communication link to authenticate mobile stations 100 attempting to access the network. The A10, A11, A12, A13 and A15 interfaces are defined in TIA-1878.

To transmit or receive packet data, the mobile station 100 establishes a packet data session with the PDSN 22. For each packet data session, the AN 42 opens a radio packet (A10) connection (also called an A10 connection) with the PDSN 22 to establish a transmission path for user data between the PDSN 22 and AN 42 for packet data. The mobile station 100 negotiates session parameters with the AN 42 and establishes a traffic channel (TCH) with the AN 42 for forward and reverse traffic. The session parameters include the protocols used for communication between the AN 42 and mobile station 100, and the protocol settings. The session parameters are stored by the session controller 48 at the AN 42.

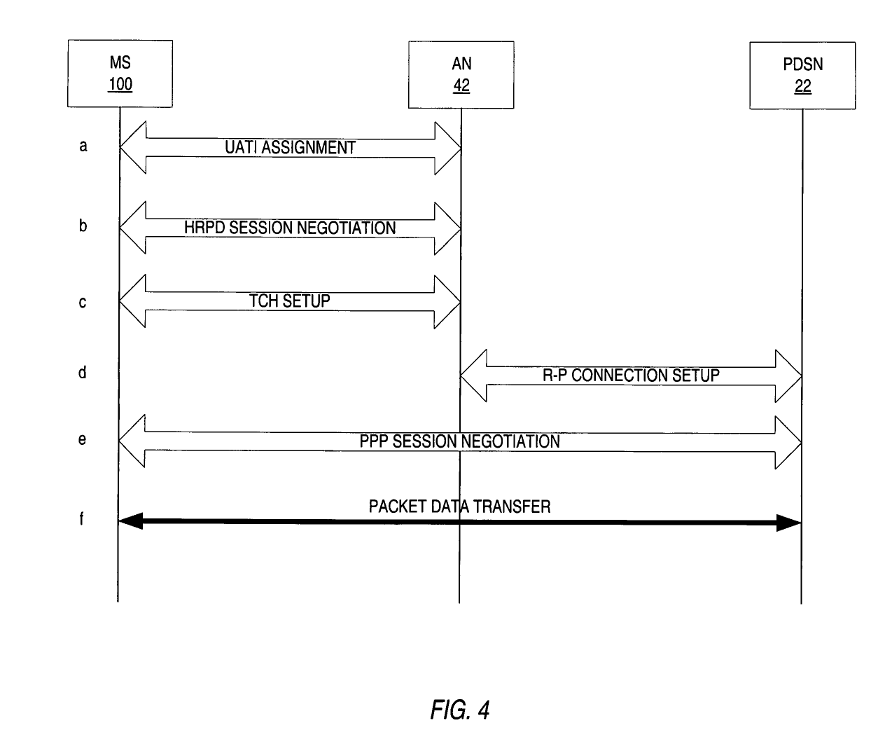

FIG. 4 illustrates an exemplary mobile initiated session establishment procedure for establishing a packet data session. The mobile station 100 requests allocation of a Universal Access Terminal Identifier (UATI) by the AN 42 (step a). The allocation of the UATI may be performed by the session controller 48. The UATI uniquely identifies the mobile station 100 to the AN 42. The UATI may be allocated from a UATI pool assigned to the AN 42. After the UATI is allocated, the mobile station 100 and AN 42 establish an HRPD session (step b). An HRPD session is a shared state between the AN 42 and mobile station 100. During the HRPD session establishment procedure, the mobile station 100 and AN 42 negotiate the protocols and protocol configurations that will be used for communications. The HRPD session information is stored and maintained by the session controller 48. The mobile station 100 and AN 42 then setup a traffic channel (step d).

The AN 42 also establishes a radio packet (A10) connection with the PDSN 22. In one exemplary embodiment, the PDSN 22 connects with the PCF 50 in the AN 42 by setting up a GRE tunnel over the A10 communication link. The mobile station 100 establishes a packet data session with the PDSN 22 (step e). A packet data session is an instance of a packet data service. In one embodiment, the mobile station 100 establishes a point to point connection with the PDSN 22 using, for example, the Point-To-Point Protocol (PPP). After establishing a PPP session, the mobile station 100 can transmit and receive packet data (step f).

During the packet data session, the mobile station 100 receives data from only one AN 42 at a time, which is referred to herein as the serving AN. When the mobile station 100 moves between cells, a handover is performed. The AN releasing the mobile station during a handover is called the source AN and the AN 42 acquiring the mobile station 100 during the handover is called the target AN 42. When the handover is complete, the target AN becomes the new serving AN.

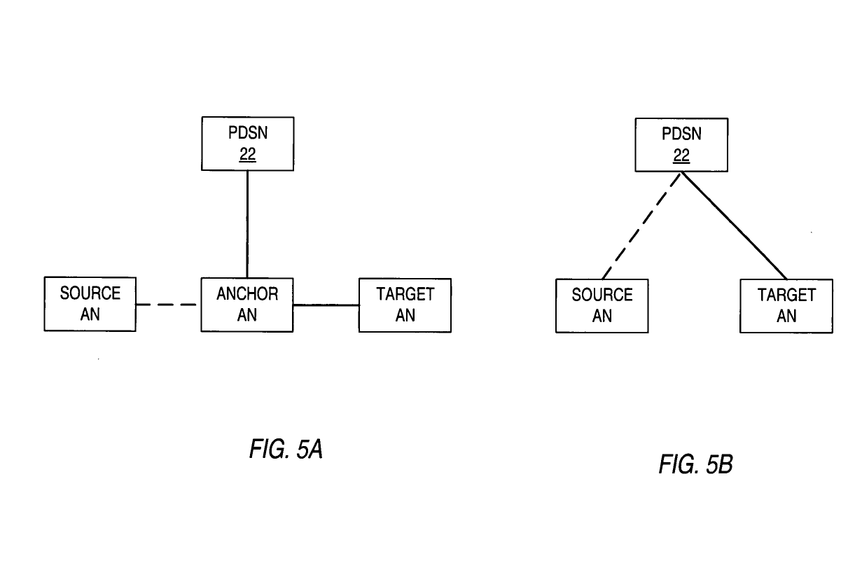

In the distributed network architecture shown in FIG. 1, a transmission path must be set up during the handover to route data to the target AN. FIG. 5A illustrates one method of setting up a transmission path from the PDSN 22 to the target AN referred to herein as the anchor method. In the anchor method shown in FIG. 5A, the AN 42 that originates the packet data call serves as an anchor and maintains the A10 connection for the duration of the packet data call. When the mobile station 100 moves into a different cell, the AN 42 in the target cell establishes a sidehaul connection with the anchor AN to establish the transmission path to the target AN and the PDSN 22 terminates its connection with the source AN. The AN 42 in the target cell then becomes the serving AN. Using this method, a significant overhead on transport resources between ANs 42 is incurred to carry packet data between ANs 42.

Another approach to establishing a transmission path to the AN 42 in the target cell, referred to herein as the mobile anchor approach, is shown in FIG. 5B. In this approach, the A10 connection is maintained by the serving AN. When the mobile station 100 move from one cell to another cell served by a different AN 42, the A10 connection is moved. In this approach, the target AN 42 establishes an A10 connection with the PDSN 22 during the handover to establish a data transmission path for packet data between the PDSN 22 and mobile station 100. The source AN releases the previously-used A10 connection.

Another problem that arises in a distributed network architecture relates to session management. When a mobile station 100 moves from one cell to another, the target AN 42 can either establish a new HRPD session with the mobile station 100, or continue the existing HRPD session. Creating a new HRPD session is not desirable due to call setup latency and possible packet loss. If the HRPD session is to be continued by the target AN 42, a method of locating and accessing the session information for the mobile station 100 needs to be provided. A related issue is where to store the session information. The session information could be maintained by a selected AN 42 for the duration of the packet data session. Alternatively, the session information can be stored by the serving AN and transferred when the mobile station 100 changes cells.

The present invention provides methods of storing, transferring, locating and accessing session information in a distributed network architecture, such as the one shown in FIG. 1. In the exemplary embodiments described herein, each AN 42 is assigned a pool of UATIs to allocate to mobile stations 100. The AN 42 that allocates the UATI to the mobile station 100 is referred to herein as the primary AN 42 and stores the session information. Each AN 42 in a subnet having knowledge of the UATI assigned to a mobile station 100 is capable of determining the address of and accessing the primary AN of that mobile station 100. The primary AN provides session information to another AN 42 upon request. The primary AN 42 performs session management functions for the HRPD session. Those skilled in the art will appreciate that the primary AN need not be the serving AN.

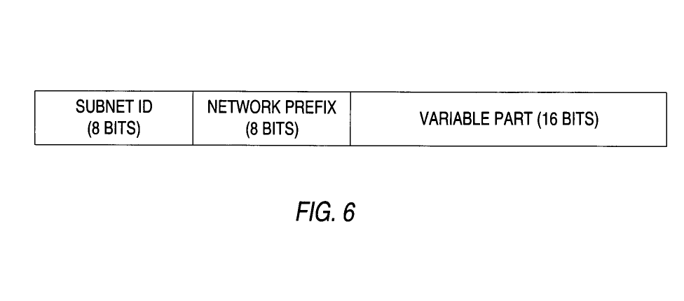

In one exemplary embodiment, The UATIs are divided among the ANs in a subnet such that each AN 42 has its own pool of UATIs, and such that each UATI is assigned to only one AN 42 in the subnet. Because each AN 42 has its own exclusive pool of UATIs, the UATI inherently identifies the AN 42 to which the UATI belongs. FIG. 6 illustrates one exemplary method of dividing available UATIs into mutually exclusive groups. In this embodiment, the UATI includes a fixed part and a variable part, where the fixed part uniquely identifies the AN 42 within the subnet. In the embodiment shown in FIG. 6, the UATI comprises 32 bits. The 16 least significant bits of the UATI are variable and are selected by the AN 42 when a packet data call is set up. These 16 bits uniquely identify the mobile station 100 to the AN 42. The 8 middle bits are fixed for a given AN 42 and uniquely identify an AN 32 within a given color code area 62. These 8 bits indicate which AN 42 in a color code area is storing the session information. The 8 most significant bits are fixed and uniquely identify a color code area 62 in a subnet 60. If the network has a single subnet, these 8 bits would not be needed. In that case, the variable part could have 24 bits rather than 16 bits. In the case where the variable part is 16 bits in length, each AN 42 has approximately 65,000 UATIs to allocate to mobile stations 100. Those skilled in the art will appreciate that additional bits could be used to identify the subnet 60 to provide unique UATIs across the entire network 10.

Those skilled in the art will appreciate that other UATI formats and other grouping methods could be used to practice the present invention. The UATIs could be grouped, for example, on the basis of a common property. In the embodiment shown in FIG. 6, the value of the fixed part of the UATI is a common property of the UATIs in the group. However, it is not required that the UATI include a fixed part or that the UATIs in a given group have a common property. The UATIs in a group could, for example, be randomly or arbitrarily chosen. Any method of dividing the UATIs into mutually exclusive groups such that the UATIs in a given group are reserved for a single AN 42 could be used. However the UATIs are divided, each AN 42 may store a mapping table in memory that maps UATI values to corresponding AN addresses. The mapping table can be used by an AN 42 to determine the address of the primary AN for the mobile station 100.

In some embodiments of the invention, a single AN 42 may be selected to serve as the primary AN for the duration of the packet data session. The AN 42 receiving a request for a UATI from the mobile station 100 may serve as the primary AN. Alternatively, the AN receiving the UATI request from the mobile station 100 may select another AN 42 in the subnet to serve as the primary AN. In some embodiments, the primary AN may be changed as the mobile station 100 moves about within the subnet. In this case, the session information is transferred to the new primary AN whenever the primary AN is changed. A new UATI can be assigned to the mobile station 100 by the new primary AN to reflect the new location of the session information.

One area of possible concern is the potential for depletion of the UATIs for an AN 42 located near an airport or other heavily-trafficked area where users are likely to place a call and then leave the subnet. This problem is referred to herein as the “airport problem.” In a typical HRPD network, a session timer is started when an HRPD session is established. When the session timer expires, the session is terminated and the UATI allocated to the mobile station is reclaimed by the AN 42. The duration of the session timer is typically in the order of 54 hours. In the exemplary embodiment described above where each AN is allocated approximately 65,000 UATIs, ANs located near an airport could possibly allocate all of its available UATIs in as little as 5 hours. One possible solution to this problem is to allocate more UATI space to mobile stations located near airports. Another possible solution is to reduce the default session timer for mobile stations 100 that establish packet data sessions at an AN located near an airport. Another third solution, referred to herein as load balancing, is to distribute the burden of maintaining session information to other ANs 42 in the subnet. Load balancing may be triggered, for example, when the number of unused UATIs available for allocation by an AN 42 reaches a minimum threshold. Once the threshold is reached, the AN 42 can transfer some of its HRPD sessions to other ANs 42 in the subnet. Additionally, the heavily loaded AN could begin forwarding UATI requests received from mobile stations 100 to other ANs 42 within the subnet.

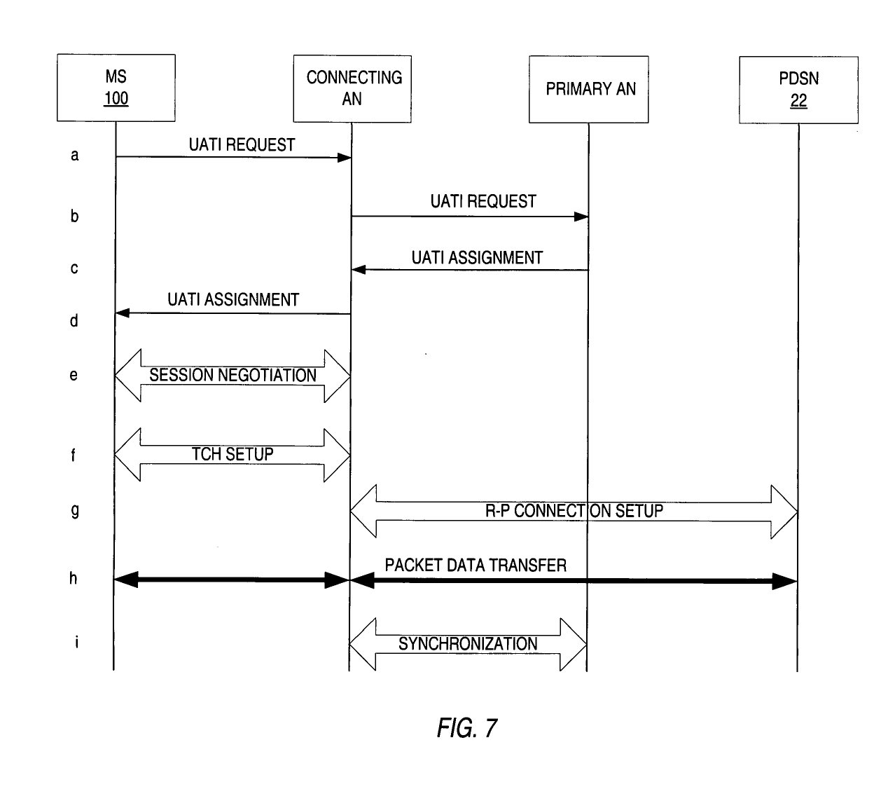

FIGS. 7-9 illustrate exemplary procedures implemented by the distributed network and give further details regarding network operation. In the exemplary procedures described below, it is assumed that the serving AN maintain the A10 connection to the PDSN 22, and that the A10 connection is moved when the mobile station 100 changes cells.

FIG. 7 illustrates an exemplary session establishment procedure. To establish a packet data session, the mobile station 100 sends a UATI request to a connecting AN (step a). As used herein, the term connecting AN refers to the AN 42 that receives a UATI request or connection request from a mobile station 100. The connecting AN selects a primary AN and sends a UATI request to the selected primary AN (step b). The primary AN can be selected randomly from the ANs 42 within the subnet 60. Random selection of the primary AN has the advantage of load balancing so that an AN located near an airport is not overloaded. The primary AN allocates an unused UATI to the mobile station and sends a UATI assignment message to the connecting AN (step c). The connecting AN sends a UATI Assignment Message over the air interface to the mobile station 100 to provide the mobile station with the allocated UATI (step d). The mobile station 100 and connecting AN negotiate parameters of the HRPD session (step e) and establish a traffic channel for communication between the mobile station and connecting AN (step f). The connecting AN also sets up an A10 connection with the PDSN 22 (step g). The connecting AN thus becomes an anchor AN. Packet data can now be sent to and from the mobile station 100 through the connecting AN (step h). After the packet data session is established, the connecting AN and primary AN perform a synchronization to transfer the session information to the primary AN (step i).

If the connecting AN serves as the primary AN, steps b, c and i are not performed. In this case, the connecting AN selects a UATI from its own UATI pool for allocation to the mobile station 100.

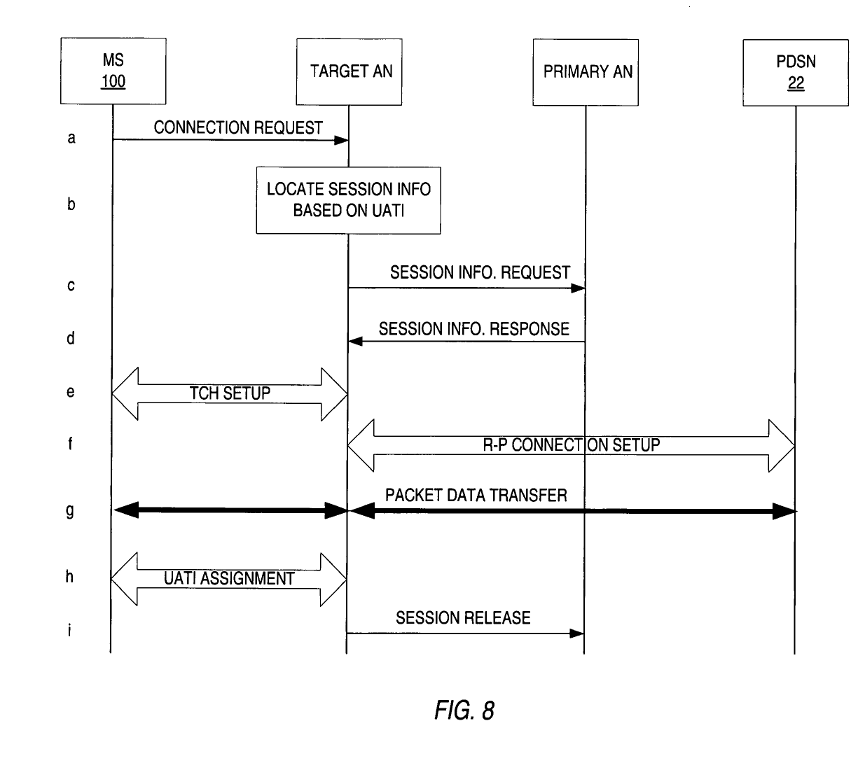

FIG. 8 illustrates an exemplary mobile-initiated reactivation procedure for reactivating a dormant packet data session according to one embodiment of the invention. When the packet data session is dormant, the mobile station 100 does not have a connection with an AN 42. When the mobile station 100 needs to send data, the mobile station 100 sends a connection request to a target AN to establish a connection with the target AN (step a). The connection request is sent over the reverse access channel. The connection request includes the UATI of the mobile station 100. Based on the UATI, the target AN determines the identity of the AN 42 where the session information for the mobile station 100 is stored (step b). The target AN sends a request for the session information to the AN 42 storing the session information (step c), which in this example is the source AN. The source AN sends the session information to the target AN (step d). After the session information is transferred to the target AN, the target AN establishes an HRPD connection with the mobile station (step e). The target AN also establishes an A10 connection with the PDSN 22 to provide a transmission path for the packet data (step f). After establishing the HRPD and A10 connections, the mobile station 100 can send and receive packet data (step g).

In some embodiments of the invention, the source AN may continue to perform the session control function for the packet data session. In this case, the session information will remain stored in the source AN. In other embodiments, the session control function may be transferred to the target AN. If the session information is transferred to the target AN and the target AN assumes the session control function, the target AN may reassign a UATI selected from its own UATI pool, since the originally-assigned UATI will not correctly identify the AN storing the session information (step h). After a new UATI is assigned, the target AN may send a session release message to the source AN and the source AN can delete the session information (step i). It should be noted that the UATI assignment and session release steps will not be performed if the session control is not transferred to the target AN. The source AN can delete the session information after it receives the session release message.

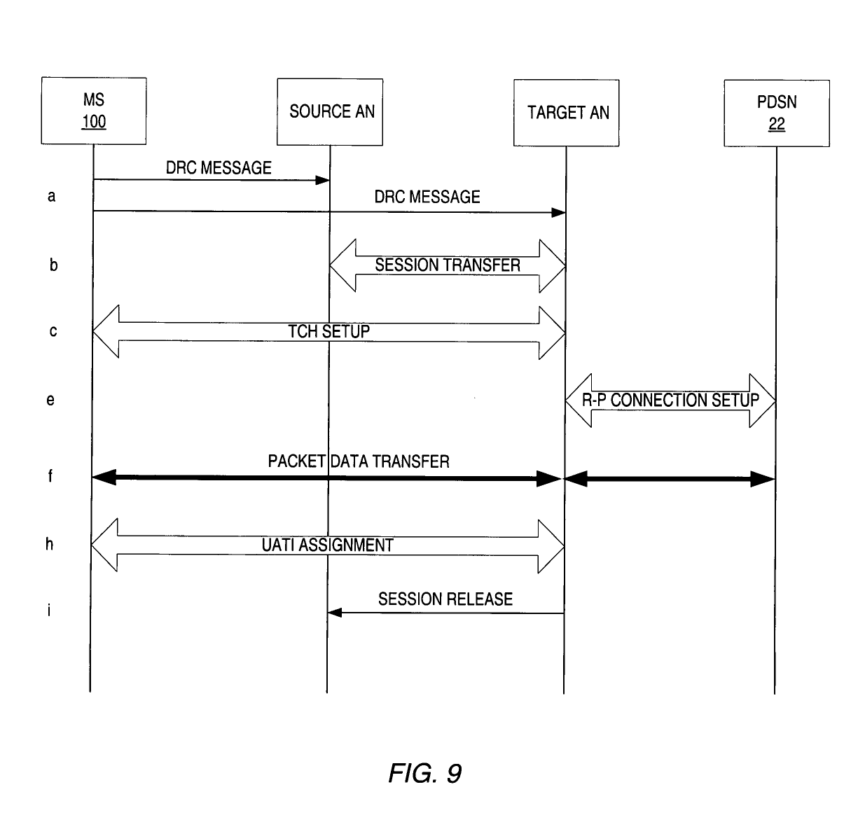

FIG. 9 illustrates a handover procedure for changing cells during an active call. In this example, it is assumed that the mobile station 100 initiates the cell change by sending a handover message to both the source AN and target AN to indicate that the mobile station is switching cells (step a). In this example, it is assumed that the source AN is serving as the primary AN. The source AN transfers session information for the mobile station 100 to the target AN (step b) and the target AN establishes a traffic channel with the mobile station (step c). The target AN establishes an A10 connection with the PDSN 22 (step d). Alternatively, the target AN could establish a side haul connection with an anchor AN for the mobile station. After the A10 connection is established, the target AN becomes the serving AN. The mobile station 100 can send and receive packet data through the target AN (step e). After session is established, the target AN assigns a new UATI to the mobile station (step f) and sends a Session Release message to the source AN (step g). The source AN removes the session.

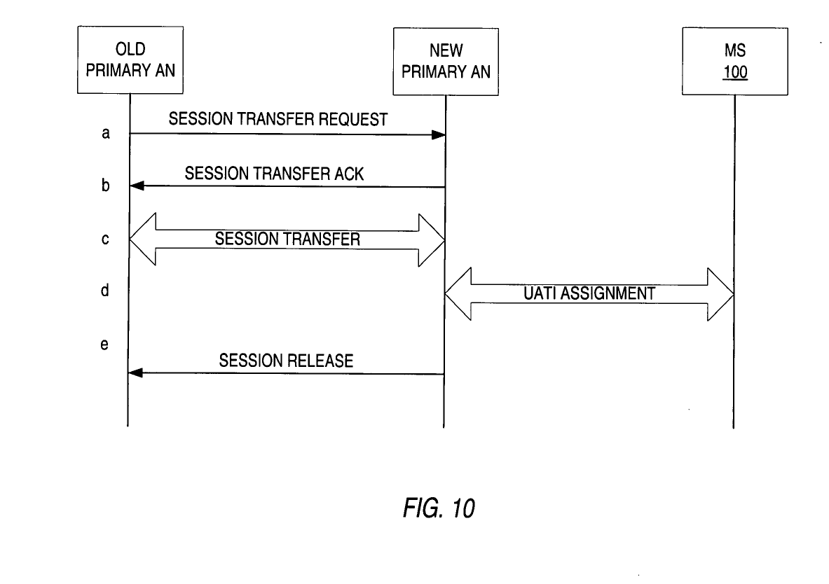

FIG. 10 illustrates a procedure for transferring an existing session to another AN 42. This procedure can be used, for example, when the primary AN 42 is overloaded or to perform load balancing. The old primary AN selects another AN 42 in the subnet 60 to be the new primary AN and sends a Session Transfer Request message to the selected AN (step a). The new primary AN send a Session Transfer Ack message to the old primary AN to acknowledge the request and indicate assent (step b). The new primary AN could, however, refuse the request. The old primary AN transfers the session to the new primary AN (step c) and the new primary AN sends a UATI Assignment message to the mobile station 100 to allocate a new UATI from its UATI pool (step d). After the session is transferred, the new primary AN sends a Session Release message to the old primary AN to initiate removal of the session at the old primary AN (step e).

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method implemented by a first access node in a mobile communication system of obtaining session information for a mobile station, said method comprising:
determining the location of session information based on a mobile station identifier allocated to said mobile station by a second access node storing the session information; and
requesting the session information from the second access node.

2. The method of claim 1 further comprising receiving said mobile station identifier from said mobile station in an access channel message.

3. The method of claim 2 wherein the access channel message comprises a connection request from the mobile station.

4. The method of claim 1 further comprising:
transferring the session information from the second access node to the first access node; and
assigning the mobile station a new mobile station identifier following transfer of said session information.

5. The method of claim 6 further comprising sending a session release message from the first access node to the second access node following the assignment of a new mobile terminal identifier.

6. The method of claim 1 wherein the second access node comprises a previous serving access node.

7. The method of claim 1 wherein the second access node comprises a primary access node that stores session information for the mobile station.

8. An access node comprising:
a transceiver circuits for establishing radio communication with a mobile station; and
a control unit to control said transceiver circuits, said control unit operative to:
determine the location of session information for a mobile station based on a mobile station identifier allocated to said mobile station by a peer access node where the session information is stored; and
request the session information from the peer access node

9. The access node of claim 8 wherein the control unit receives said mobile station identifier from said mobile station in an access channel message.

10. The access node of claim 8 wherein the access channel message comprises a connection request from the mobile station to establish a connection with the access node.

11. The access node of claim 8 wherein said control unit is further operative to:
receive the session information from the peer access node responsive to said request; and
assign the mobile station a new mobile station identifier following receipt of said session information.

12. The access node of claim 11 wherein said control unit is further operative to send a session release message to the peer access node following the assignment of a new mobile terminal identifier to trigger the release of the session information by the other access node

13. The access node of claim 8 wherein the peer access node comprises a previous serving access node.

14. The access node of claim 8 wherein the peer access node comprises a primary access node that stores session information for the mobile station.

15. A method of transferring session information between access nodes in a mobile communication system comprising a plurality of access nodes, said method comprising:
receiving an indication from a mobile station engaged in a communication session that said mobile station is switching from a source access node to a target access node; and
transferring session information for said communication session from said source access node to said target access node responsive to said indication; and
assigning a mobile station identifier to said mobile station to use for said communication session following transfer of said session information to said target access node, said mobile station identifier being selected from a from a pool of mobile station identifiers controlled by said target access node.

16. The method of claim 15 further comprising:
sending a session release message from said target access node to said source access node following transfer of said session information;
releasing said session information at said source access node responsive to said session release message.

17. A method of transferring session information between access nodes in a mobile communication system comprising a plurality of access nodes, said method comprising:
receiving a connection request at a target access node from a mobile station engaged in a communication session;
transferring session information for said communication session from a source access node to said target access node responsive to said connection request; and
assigning a mobile station identifier to said mobile station to use for said communication session following transfer of said session information to said target access node, said mobile station identifier being selected from a from a pool of mobile station identifiers controlled by said target access node.

18. The method of claim 17 further comprising:
sending a session release message from said target access node to said source access node following transfer of said session information; and
releasing said session information at said source access node responsive to said session release message.

19. A method of transferring session information between access nodes in a mobile communication system comprising a plurality of access nodes, said method comprising:
transferring session information for a mobile station engaged in a communication session from a source access node to a target access node responsive to said mobile station moving between cells in a mobile communication network; and
assigning a mobile station identifier to said mobile station to use for said communication session following transfer of said session information to said target access node, said mobile station identifier being selected from a from a pool of mobile station identifiers controlled by said target access node.

20. The method of claim 19 further comprising:
sending a session release message from said target access node to said source access node following transfer of said session information; and
releasing said session information at said source access node responsive to said session release message.
